(19) United States
(12) Patent Application Publication
(10) Pub. No.: US 2019/0101478 A1
(43) Pub. Date: Apr. 4, 2019

(54) MICROBIAL AUTOMATIC STAINING PLATFORM SYSTEM INCLUDING PRETREATMENT PROCESS

(71) Applicant: KOREA STANDARD CO., LTD., Seongnam-si (KR)

(72) Inventor: Ji Hyun SHIN, Goyang-si (KR)

(21) Appl. No.: 16/207,612

(22) Filed: Dec. 3, 2018

(30) Foreign Application Priority Data
Jan. 17, 2017 (KR) 10-2017-0008310

(51) Int. Cl. G01N 1/31

(52) U.S. Cl. CPC G01N 1/31

(57) ABSTRACT

The present disclosure relates a microbial automatic staining platform system including a pretreatment process so that the pretreatment and staining of microorganisms are capable of being completed rapidly through an automation process. In other words, the present invention is characterized by providing the microbial automatic staining platform system capable of automatically staining microorganisms by a pretreatment process. Therefore, the present invention has an effect in which the pretreatment and staining of microorganisms are capable of being achieved in a rapid and safe manner through an automation process.

### CROSS-REFERENCE TO RELATED APPLICATIONS

This application claims the priority of Korean Patent Application No. 10-2017-0008310 filed on Jan. 17, 2017, in the Korean Intellectual Property Office, the disclosure of which is hereby incorporated by reference in its entirety.

### BACKGROUND

### 1. Technical Field

The present disclosure relates to a microbial automatic staining platform system including a pretreatment process, and more particularly, to a microbial automatic staining platform system capable of automatically staining microorganisms by a pretreatment process so that the pretreatment and staining of microorganisms are capable of being completed rapidly through an automation process.

### 2. Description of the Related Art

In general, Mycobacterium tuberculosis, which is one of microorganisms, is one of the three major infectious diseases in the world and ranked first in mortality among OECD countries.

Inspection of microorganisms such as Mycobacterium tuberculosis as described above is performed by manual operation, thus causing problems in that the inspection is ineffective and there is a risk of infection during an inspection process.

In addition, at present, even though all the inspection systems are automated in each part of Department of diagnostic tests, a staining operation of a microbial part such as Mycobacterium tuberculosis is still performed manually, and an inspector is most likely to be in contact with a specimen for identifying microorganisms such as Mycobacterium tuberculosis in performing the operation, and thus there is a high risk that the inspector is infected by the specimen.

### Related Art Document

(Patent Document 1) Korean Patent No. KR 10-1579231

### SUMMARY

It is an object of the present disclosure to provide a microbial automatic staining platform system capable of solving a high risk of infection in an inspector by exposure to microorganisms such as Mycobacterium tuberculosis since a staining operation of a microbial part such as Mycobacterium tuberculosis is performed by manual operation of the inspector.

Objects of the present disclosure are not limited to the above-described objects and other objects and advantages can be appreciated by those skilled in the art from the following descriptions. Further, it will be easily appreciated that the objects and advantages of the present disclosure can be practiced by means recited in the appended claims and a combination thereof.

In accordance with one aspect of the present disclosure, there is provided a microbial automatic staining platform system capable of automatically staining microorganisms by a pretreatment process.

The microbial automatic staining platform system includes: an automatic staining frame that forms an apparatus installation space on an upper part and forms an operation space opened in all directions, a robot arm that is mounted at an upper side of the operation space of the automatic staining frame to automatically transport a specimen, a sample rack that is provided at one side of the operation space so that samples taken from an inspection object are placed, a specimen recognizing unit that is provided at one side of the sample rack to clearly recognize the specimen according to the inspection object by a barcode reader, a centrifuge that is provided at one side of the operation space to centrifugally separate the specimen taken from the inspection object at 3,000 rpm for 15 minutes after mixing the specimen with a homogenizing material, a specimen fixing and dispensing apparatus provided at one side of the centrifuge to apply and fix the centrifuged specimen on a slide, a specimen staining apparatus provided at one side of the operation space to stain the specimen fix to the slide, a medium dispensing apparatus provided at one side of the operation space to dispense the strain remaining on the slide to a medium, and a staining controlling unit that controls the robot arm so as to perform recognition of the specimen, homogenization, centrifugation, slide fixation, and medium distribution.

### BRIEF DESCRIPTION OF DRAWINGS

FIG. 1 is an exemplary view showing an exemplary embodiment of the present invention.

FIGS. 2 to 7 are exemplary views showing main apparatuses according to the present invention.

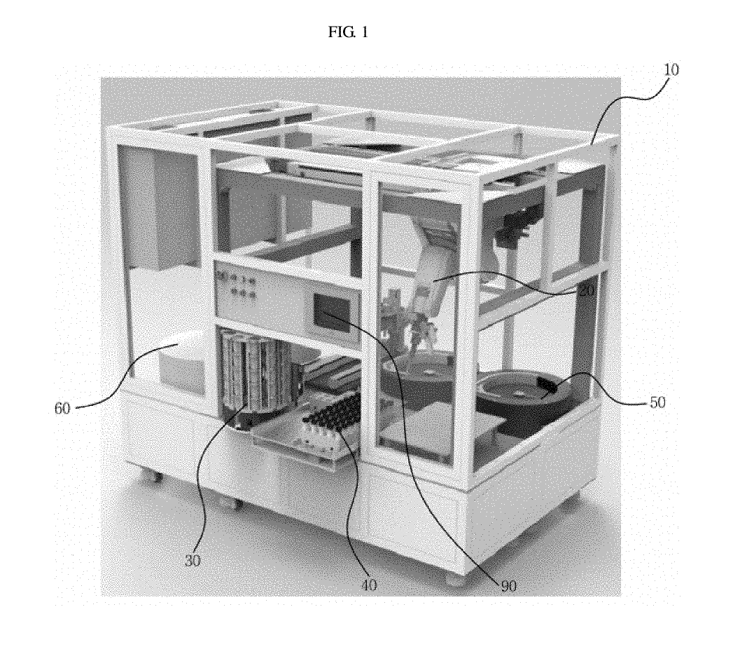

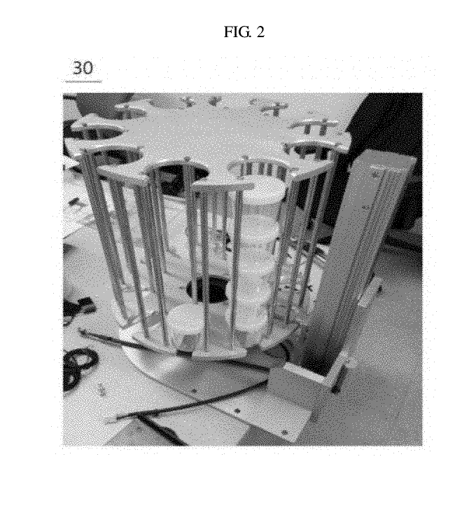

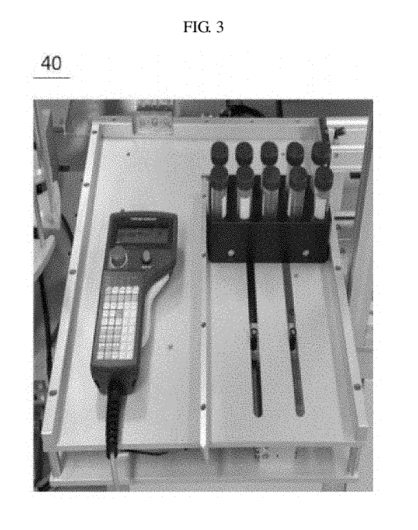

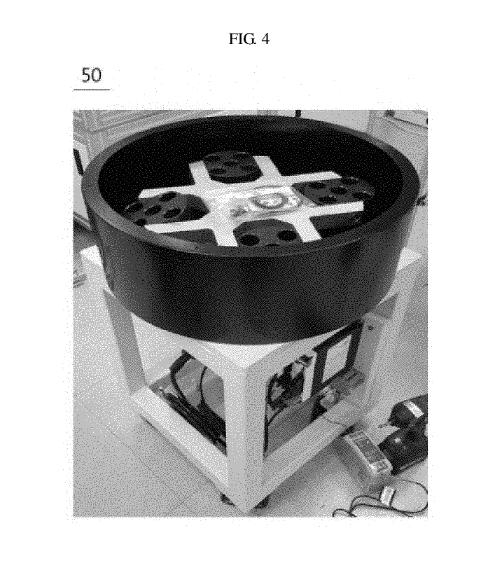

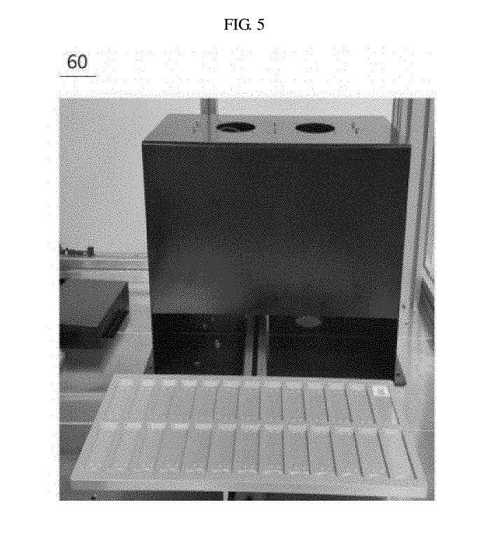

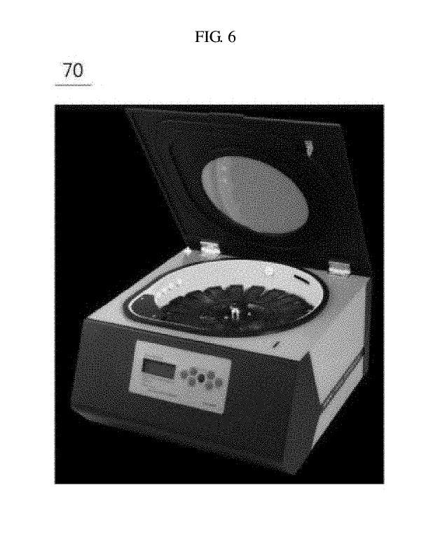

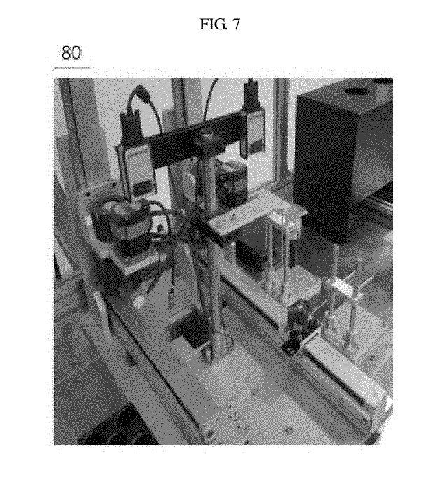

### DETAILED DESCRIPTION

Hereinafter, the present invention is described in detail with reference to the accompanying drawings.

The present invention provides pretreatment and staining of microorganisms through an automation process achieved in a rapid and safe manner. Terms and words used in the present specification and claims should not be construed as being limited to general or dictionary terms. These terms and words should be construed in view of the meanings and concepts consistent with the technical idea of the present invention based on the principle that the inventor can properly define the concept of a term to explain the invention in the best way.

Therefore, configurations described in an exemplary embodiment and the drawings of the present specification are merely the most preferable exemplary embodiment of the present invention, and do not represent all the technical ideas of the present invention. Thus, the present invention should be construed as including various equivalents and variations that may be substituted at the time of filing the present application.

In other words, the present invention provides a microbial automatic staining platform system capable of automatically staining microorganisms by a pretreatment process.

The automatic microbiological platform system includes an automatic staining frame 10, a robot arm 20, a sample rack 30, a specimen recognizing unit 40, a centrifuge 50, a specimen fixing and dispensing apparatus 60, a specimen staining apparatus 70, a medium dispensing apparatus 80, and a staining controlling unit 90.

Here, the automatic staining frame 10 forms an apparatus installation space on an upper part and forms an operation space opened in all directions.

In addition, the robot arm 20 is mounted at an upper side of the operation space of the automatic staining frame, has a short-joint structure so as to automatically transport a specimen, and includes, pneumatic or hydraulic, and solenoid actuators.

Further, the sample rack 30 is formed in a cylindrical storage frame at one side of the operation space so that samples taken from an inspection object are capable of being placed.

In addition, the specimen recognizing unit 40 is provided at one side of the sample rack so as to clearly recognize the inspection object according to the taken specimen, and includes a barcode reader.

Further, a centrifuge 50 is provided at one side of the operation space to centrifugally separate the specimen taken from the inspection object at 3,000 rpm for 15 minutes after mixing the specimen with a homogenizing material.

Further, the specimen fixing and dispensing apparatus 60 is provided at one side of the centrifuge 50 to apply and fix the centrifuged specimen on a slide.

Further, the specimen staining apparatus 70 is provided at one side of the operation space to clean and stain the specimen fix to the slide.

Further, the medium dispensing apparatus 80 is provided at one side of the operation space to dispense the strain remaining on the slide to a medium.

In addition, the staining controlling unit 90 controls the robot arm 20 so as to perform recognition of the specimen, homogenization, centrifugation, slide fixation, and medium distribution.

Hereinafter, action effects obtained by applying the present invention are described.

As described above, by applying and practicing the present invention according to the microbial automatic staining platform system capable of automatically staining microorganisms by the pretreatment process, the microbial automatic staining platform system including: an automatic staining frame 10 that forms an apparatus installation space on an upper part and forms an operation space opened in all directions, a robot arm 20 that is mounted at an upper side of the operation space of the automatic staining frame 10 to automatically transport a specimen, a sample rack 30 that is provided at one side of the operation space so that samples taken from an inspection object are placed, a specimen recognizing unit 40 that is provided at one side of the sample rack 30 to clearly recognize the specimen according to the inspection object by a barcode reader, a centrifuge 50 that is provided at one side of the operation space to centrifugally separate the specimen taken from the inspection object at 3,000 rpm for 15 minutes after mixing the specimen with a homogenizing material, a specimen fixing and dispensing apparatus 60 provided at one side of the centrifuge 50 to apply and fix the centrifuged specimen on a slide, a specimen staining apparatus 70 provided at one side of the operation space to stain the specimen fix to the slide, a medium dispensing apparatus 80 provided at one side of the operation space to dispense the strain remaining on the slide to a medium, and a staining controlling unit 90 that controls the robot arm 20 so as to perform recognition of the specimen, homogenization, centrifugation, slide fixation, and medium distribution, and thus the pretreatment and staining of the microorganisms are achieved in a rapid and safe manner through an automation process.

Therefore, the present invention provides a microbial automatic staining platform system capable of automatically staining microorganisms by a pretreatment process so that the pretreatment and staining of microorganisms are capable of being achieved in a rapid and safe manner through an automation process.

The present disclosure described above may be variously substituted, altered, and modified by those skilled in the art to which the present invention pertains without departing from the scope and sprit of the present disclosure. Therefore, the present disclosure is not limited to the above-mentioned exemplary embodiments and the accompanying drawings.

### DETAILED DESCRIPTION OF MAIN ELEMENTS

10: Automatic staining frame

20: Robot arm

30: Sample rack

40: Specimen recognizing unit

50: Centrifuge

60: Specimen fixing and dispensing apparatus

70: Specimen staining apparatus

80: Medium dispensing apparatus

90: Staining controlling unit

What is claimed is:

1. A microbial automatic staining platform system including a pretreatment process capable of automatically staining microorganisms by the pretreatment process, the microbial automatic staining platform system comprising:
an automatic staining frame 10 that forms an apparatus installation space on an upper part and forms an operation space opened in all directions,
a robot arm 20 that is mounted at an upper side of the operation space of the automatic staining frame 10 to automatically transport a specimen,
a sample rack 30 that is provided at one side of the operation space so that samples taken from an inspection object are placed,
a specimen recognizing unit 40 that is provided at one side of the sample rack 30 to clearly recognize the specimen according to the inspection object by a barcode reader,
a centrifuge 50 that is provided at one side of the operation space to centrifugally separate the specimen taken from the inspection object at 3,000 rpm for 15 minutes after mixing the specimen with a homogenizing material,
a specimen fixing and dispensing apparatus 60 provided at one side of the centrifuge 50 to apply and fix the centrifuged specimen on a slide,
a specimen staining apparatus 70 provided at one side of the operation space to stain the specimen fix to the slide,
a medium dispensing apparatus 80 provided at one side of the operation space to dispense the strain remaining on the slide to a medium, and
a staining controlling unit 90 that controls the robot arm 20 so as to perform recognition of the specimen, homogenization, centrifugation, slide fixation, and medium distribution.
